(19) United States
(12) Patent Application Publication
(10) Pub. No.: US 2008/0147717 A1
(43) Pub. Date: Jun. 19, 2008

(54) IMAGE FORMING METHOD AND APPARATUS

(75) Inventors: Gurunathan RAJENDRAN GANDHI, Bangalore (IN); Bisht Deepak, Bangalore (IN); Sathaiah Dontula, Bangalore (IN); Guruvare Gopalakrishna Holla Mangalpay, Bangalore (IN)

Correspondence Address: STANZIONE & KIM, LLP, 919 18TH STREET, N.W., SUITE 440, WASHINGTON, DC, 20006, US

(73) Assignee: Samsung Electronics Co., Ltd., Suwon-si (KR)

(21) Appl. No.: 11/958,627

(22) Filed: Dec. 18, 2007

(30) Foreign Application Priority Data
Dec. 19, 2006 (IN) 2357/CHE/2006
Jul. 31, 2007 (KR) 2007-77184

(51) Int. Cl. G06F 17/30

(52) U.S. Cl. 707/102; 707/E17.019

(57) ABSTRACT

A method includes connecting an external storage medium to an image forming apparatus, generating a file directory structure of files stored in the external storage medium and identification signals respectively corresponding to the files, printing the generated file directory structure and the identification signals, and printing files corresponding to the selected identification signal of the printed identification signals, and an apparatus to perform the method. Thus, a file can be printed by easily selecting a file stored in an external storage medium connected to the image forming apparatus that does not include a user display interface.

### CROSS-REFERENCE TO RELATED APPLICATIONS

This application claims the benefits of India Patent Application No. 2357-CHE-2006, filed on Dec. 19, 2006, and Korean patent application No. 10-2007-0077184, filed on Jul. 31, 2007, in the Korean Intellectual Property Office, the disclosures of which is incorporated herein in are entirety by reference.

### BACKGROUND OF THE INVENTION

1. Field of the Invention

The present general inventive concept relates to a method of forming an image using an image forming apparatus such as a printer or an office automation apparatus, and more particularly, to a method of forming an image by readily selecting a file stored in an external storage medium connected to an image forming apparatus that does not have a user display interface, and an image forming apparatus to perform the method.

2. Description of the Related Art

Some of conventional image forming apparatuses include a user display interface, and some do not. If an image forming apparatus includes a user display interface, the file directory structure and types of files stored in an external storage medium can be found via the user display interface by connecting the external storage medium to the image forming apparatus, and thus printing a desired file can be easily performed by first viewing the file.

However, when the conventional image forming apparatus does not include a user display interface, the file directory structure and types of files stored in an external storage medium can not be found even though the external storage medium is connected to the image forming apparatus, and accordingly, a user cannot print a desired file.

### SUMMARY OF THE INVENTION

The present general inventive concept provides a method of forming an image by which a file stored in an external storage medium connected to an image forming apparatus can be printed even when the image forming apparatus does not have a user display interface, and an image forming apparatus to perform the method.

Additional aspects and utilities of the present general inventive concept will be set forth in part in the description which follows and, in part, will be obvious from the description, or may be learned by practice of the general inventive concept.

The foregoing and/or other aspects and utilities of the present general inventive concept can be achieved by providing an image forming method including: connecting an external storage medium to an image forming apparatus; generating a file directory structure of files stored in the external storage medium and identification signals respectively corresponding to the files; printing the generated file directory structure and the identification signals; and printing files corresponding to the selected identification signal of the printed identification signals.

The foregoing and/or other aspects and utilities of the present general inventive concept can also be achieved by providing an image forming apparatus including: a interface unit that is connected to an external storage medium and receives information of files stored in the external storage medium; a file directory structure and identification signal generation unit that generates a file directory structure of the files and identification signals respectively corresponding to the files using the received file information; and a printing engine unit that prints the generated file directory structure and the identification signals and prints a file corresponding to the selected identification signal of the printed identification signals.

The foregoing and/or other aspects and utilities of the present general inventive concept can also be achieved by providing an image forming method including reading files stored in an external storage medium; generating a file directory structure of the read files and indicators corresponding to each of the files; printing the generated file directory structure and the corresponding indicators; and printing files corresponding to selected ones of the indicators.

The reading of files stored in an external storage medium can be performed wired or wirelessly.

### BRIEF DESCRIPTION OF THE DRAWINGS

These and/or other aspects and utilities of the present general inventive concept will become apparent and more readily appreciated from the following description of the embodiments, taken in conjunction with the accompanying drawings of which:

FIG. 1 is a flow chart of an image forming method according to an embodiment of the present general inventive concept;

FIG. 2 is an example of a file stored in an external storage medium, according to an embodiment of the present general inventive concept;

FIG. 3 is a flow chart explaining operation 101 of FIG. 1, according to an embodiment of the present general inventive concept;

FIG. 4 is an example of a printed directory structure and identification signals, according to an embodiment of the present general inventive concept;

FIG. 5 is a flow chart explaining operation 104 of FIG. 1, according to an embodiment of the present general inventive concept; and

FIG. 6 is a block diagram of an image forming apparatus according to an embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

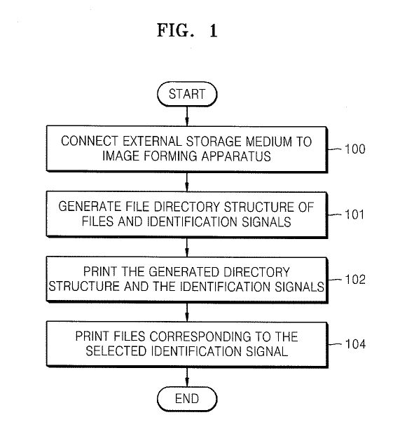

FIG. 1 is a flow chart of an image forming method according to an embodiment of the present general inventive concept.

An external storage medium can be connected to an image forming apparatus (Operation 100). The external storage medium may be a digital camera, a USB memory, or the like. However, the image forming apparatus can alternatively read data from the external storage medium via a wireless connection.

After connecting the external storage medium to the image forming apparatus, identification signals corresponding to files and the file directory structure of the files in the external storage device are generated using information of the files stored in the external storage medium (Operation 101).

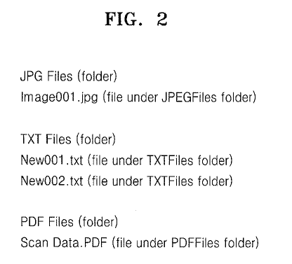

FIG. 2 is an example of a file stored in the external storage medium, according to an embodiment of the present general inventive concept.

The file directory structure denotes a hierarchical list of the files stored in the external storage medium. Also, identification signals are index information of each file, and, in the present embodiment, are serial numbers. The serial number can be selected through at least one input-key.

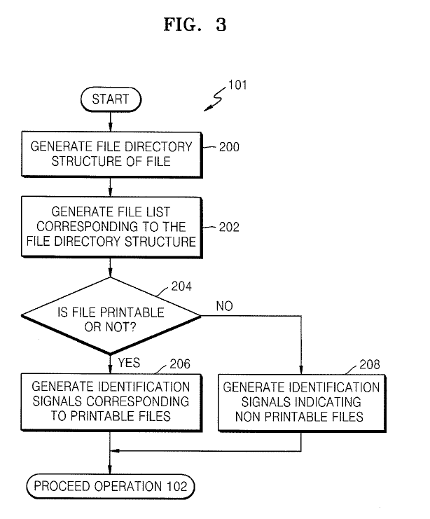

FIG. 3 is a flow chart of the operation 101 of FIG. 1, according to an embodiment of the present i general inventive concept.

The file directory structures of files stored in an external storage medium is generated (Operation 200). A hierarchical list, that is, the file directory structure, is generated using a conventional file system interface function.

After the operation 200, a file list corresponding to the generated file directory structure is generated (Operation 202). For example, a list of files included in each folder depicted in FIG. 2 is generated.

After the operation 202, files that can be printed are detected from the file list (Operation 204).

If the files that can be printed via an image forming apparatus are detected from the file list, identification signals corresponding to each of the files that can be printed are generated (Operation 206). According to an example of the present embodiment, the identification signals are allocated sequentially in serial numbers.

However, if files that cannot be printed via the image forming apparatus are detected in the list, identification signals that indicate that files cannot be printed are generated (Operation 208).

After the Operation 101, the generated file directory structure and the identification signals are printed (Operation 102).

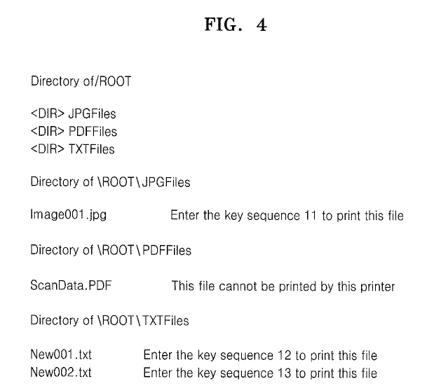

FIG. 4 is an example of a printed file directory structure and identification signals. The file directory structure and identification signals of files depicted in FIG. 4 denote the file directory structure and identification signals of the files stored in the external storage medium depicted in FIG. 2. As depicted in FIG. 4, the “Image001.jpg” file that belongs to the “JPG Files” folder is printed with a serial number “11,” and the files “New001.txt” and “New002.txt” that belong to the “TXT Files” folder are respectively printed with serial numbers “12” and “13.” However, the “Scan Data. PDF” file that belongs to the “PDF Files” folder is printed with a message “This file cannot be printed by the printer,” that is, a message that the “Scan Data.PDF” file cannot be printed via the image forming apparatus.

After the Operation 102, files corresponding to selected identification signals of the printed identification signals are printed (Operation 104).

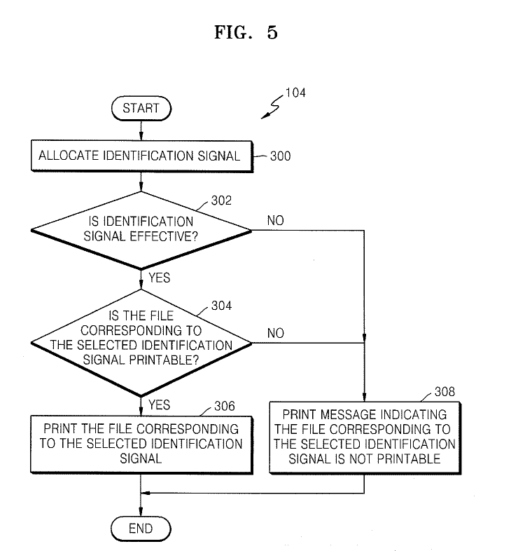

FIG. 5 is a flow chart of the operation 104 of FIG. 1, according to an embodiment of the present general inventive concept.

An identification signal from among the printed identification signals is selected (Operation 300). The user confirms the file directory structure and identification signals, and inputs an identification signal corresponding to a file to be printed using an input key. The input key can be a number key or a button type key. If the input key is a button type key, the identification signals can be input by pressing the button as many times as the identification signals, that is, a serial number corresponding to the identification signals.

After the operation 300, it is examined whether the selected identification signal is one identification signal corresponding to files in the external storage medium (Operation 302). If the identification signal input by a user matches one of the identification signals allocated to the files in the external storage medium, the identification is proved as effective.

If the selected identification signal is one of the identification signals corresponding to the files in the external storage medium, it is examined whether the file corresponding to the selected identification signal can be printed (Operation 304).

If the file corresponding to the selected identification signal is a printable file, the file corresponding to the selected identification signal is printed (Operation 306).

However, if the file corresponding to the selected identification signal is not printable or the identification signal input by a user in the operation 302 is identified as ineffective, a message that ‘the file corresponding to the selected identification signal cannot be printed’ is printed (Operation 308).

The exemplary image forming method described above is useful for an image forming apparatus that does not have a display unit of a user interface. In an image forming apparatus that includes a user interface, a list of files stored in an external storage medium can be confirmed through a display window of the user interface, and thus, it is unnecessary to print the file directory structure and identification signals as in the present embodiment. However, an image forming apparatus that does not include a user interface, like one described in the present embodiment, a file to be printed by a user can be printed by confirming the file directory structure and identification signals of the files stored in an external storage medium.

The image forming method according to the present embodiment described above can be realized as computer readable codes/instructions/programmes. That is, a computer readable recording medium, in which programs to execute the operation of generating identification signals corresponding to the file directory structure of each of the files stored in the external storage medium and the files, printing the generated file directory structure and identification signals, and printing files corresponding to the selected identification signals of the printed identification signals are recorded when an external storage medium is connected to an image forming apparatus, is another embodiment of the present general inventive concept.

For example, the image forming method according to the embodiment described above can be realized in general-use digital computers that execute codes/instructions/programmes using a computer readable recording medium. Examples of the computer readable recording medium include magnetic storage media (e.g., ROM, floppy disks, hard disks, etc.), optical recording media (e.g., CD-ROMs, or DVDs), and storage media such as carrier waves (e.g., transmission through the Internet). Also, the embodiments of the present general inventive concept can be realized in medium (media) storing computer readable codes, and the medium (media) can be distributed to a plurality of computer systems connected through a network so that the computer readable code is executed in the distributed computer systems. Also, functional programs, codes, and code segments for accomplishing the embodiments described above can be easily construed by programmers skilled in the art to which the present general inventive concept pertains.

An image formation apparatus according to an embodiment of the present general inventive concept will now be described with reference to the accompanying drawing.

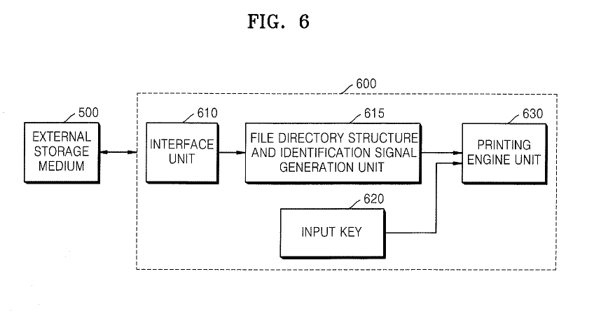

FIG. 6 is a block diagram of an image forming apparatus 600 according to an embodiment of the present general inventive concept. The image forming apparatus 600 includes an interface unit 610, a file directory structure and identification signal generation unit 615, an input key 620, and a printing engine unit 630.

The interface unit 610 can be connected to an external storage medium 500, receive information of files stored in the external storage medium 500, and output the received information of files to the file directory structure and identification signal generation unit 615. This connection can be performed via wire or wirelessly.

The file directory structure and identification signal generation unit 615 generates identification signals corresponding to the files and the file directory structure, and outputs the generated results to the printing engine unit 630. Here, the identification signal is a serial number corresponding to each of the files.

The file directory structure and identification signal generation unit 615 generates a file directory structure of the files, and also generates a file list corresponding to the generated file directory structure. Afterwards, the file directory structure and identification signal generation unit 615 detects files that are printable, and also generates identification signals corresponding to each of the printable files. Also, the file directory structure and identification signal generation unit 615 generates identification signals regarding files that are not printable.

The input key 620 can be configured to number keys or in a button type key. If the input key 620 is a button type key, the input key 620 can recognize the number of times being pressed as serial numbers. A result input using the input key 620 is output to the print engine unit 630.

The printing engine unit 630 prints a content indicating the file directory structure and identification signals in response to the file directory structure and identification signals received from the file directory structure and identification signal generation unit 615. The file directory structure and identification signals of FIG. 4 are an example with regard to the file of FIG. 2.

Also, the printing engine unit 630 prints a file corresponding to identification signals selected through the input key 620. If the user confirms the identification signals corresponding to a file to be printed with reference to the printed directory structure and identification signals, the identification signals are input through the input key 620. The printing engine unit 630 prints a file corresponding to the input identification signals according to the input result of the input key 620. For this purpose, the printing engine unit 630 examines whether the selected identification signal of the printed identification signals is an identification signal corresponding to the files in the external storage medium 500. If the selected identification signal is an identification signal corresponding to the files in the external storage medium 500, the printing engine unit 630 examines whether the file corresponding to the selected identification signal is printable. If the selected file corresponding to the selected identification signal is printable, the printing engine unit 630 prints the file corresponding to the selected identification signal. However, if the file corresponding to the selected identification signal is not printable, the printing engine unit 630 prints a message indicating that the file corresponding to the selected identification signal cannot be printed.

The image forming apparatus 600 may not include the display unit of the user interface.

According to the image forming method and the image forming apparatus of the embodiment of the present general inventive concept, a file stored in an external storage medium connected to the image forming apparatus can be easily printed after being selected by a user.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. An image forming method comprising:
connecting an external storage medium to an image forming apparatus;
generating a file directory structure of files stored in the external storage medium and identification signals corresponding to the files;
printing the generated file directory structure and the identification signals; and
printing files corresponding to a selected identification signal of the printed identification signals.

2. The image forming method of claim 1, wherein the identification signals are selected through at least one input key.

3. The image forming method of claim 1, wherein the generating of the identification signals comprises:
generating a file list corresponding to the generated file directory structure; and
generating the identification signals corresponding to each of the files in the file list.

4. The image forming method of claim 3, further comprising:
generating identification signals indicating that files cannot be printed with respect to files that are not printable.

5. The image forming method of claim 1, wherein the printing of the files comprises:
selecting an identification signal from the printed identification signals;
determining whether the file corresponding to the selected identification signal is printable; and
printing the file that corresponds to the selected identification signal if the file corresponding to the selected identification signal is printable.

6. The image forming method of claim 5, further comprising:
printing a message indicating that the file corresponding to the selected identification signal cannot be printed if the file corresponding to the selected identification signal is determined not to be printable.

7. The image forming method of claim 1, wherein the image forming method is performed in an image forming apparatus that does not have a display unit of a user interface.

8. A recording medium that is readable by a computer and comprises programs to perform a method of:
connecting an external storage medium to an image forming apparatus;
generating a file directory structure of files stored in the external storage medium and identification signals corresponding to the files;
printing the generated file directory structure and the identification signals; and
printing files corresponding to the selected identification signal of the printed identification signals.

9. An image forming apparatus comprising:
a interface unit that connects to an external storage medium and receives information of files stored in the external storage medium;
a file directory structure and identification signal generation unit that generates a file directory structure of the files and identification signals corresponding to the files using the received file information; and
a printing engine unit that prints the generated file directory structure and the identification signals and also prints a file corresponding to a selected identification signal of the printed identification signals.

10. The image forming apparatus of claim 9, further comprising:
at least an input key to select the identification signals.

11. The image forming apparatus of claim 9, wherein the file directory structure and identification signal generation unit further generates a file list corresponding to the file directory structure and identification signals corresponding to each of the files in the file list.

12. The image forming apparatus of claim 11, wherein the file directory structure and identification signal generation unit generates identification signals indicating that files cannot be printed with respect to the files that are not printable.

13. The image forming apparatus of claim 9, wherein the printing engine unit determines whether the file corresponding to the selected identification signal of the printed identification signals is printable, and if the file corresponding to the selected identification signal is printable, prints the file corresponding to the selected identification signal.

14. The image forming apparatus of claim 9, wherein, if the file corresponding to the selected identification signal is unprintable, the printing engine unit prints a message that indicates the file corresponding to the selected identification signal is not printable.

15. The image forming apparatus of claim 9, wherein the image forming apparatus does not comprise a display unit of a user interface.

16. An image forming method comprising:
reading files stored in an external storage medium;
generating a file directory structure of the read files and indicators corresponding to each of the files;
printing the generated file directory structure and the corresponding indicators; and
printing files corresponding to selected ones of the indicators.

17. The method of claim 16, wherein the reading of files is performed by wirelessly obtaining file data stored in the external storage medium.

18. The method of claim 16, wherein the reading of files is performed by providing a wired connection to the external storage medium.
